(19) United States
(12) Patent Application Publication
(10) Pub. No.: US 2017/0336649 A1
(43) Pub. Date: Nov. 23, 2017

(54) EYEGLASSES WITH CHANGEABLE FRAME

(71) Applicant: PROHERO GROUP CO., LTD., TAINAN CITY (TW)

(72) Inventor: PEN-WEI CHEN, TAINAN CITY (TW)

(21) Appl. No.: 15/156,518

(22) Filed: May 17, 2016

(51) Int. Cl. G02C 5/00

(52) U.S. Cl. CPC G02C 5/00; G02C 2200/08

(57) ABSTRACT

Eyeglasses with a changeable frame are revealed. The eyeglasses include an upper frame and a lower frame. The upper frame and the lower frame have a lens assembly portion and a lens assembly part, respectively. The upper frame and the lower frame are disposed with locking slots and projections respectively. The projections are corresponding to and joined with the locking slots. The upper frame and the lower frame are connected into one part by locking protrusions of the projection into the concaves of the locking slots correspondingly. Thus users can assemble or disassemble the upper frame with the lower frame for changing the eyeglasses into half-frame eyeglasses or full-frame eyeglasses.

### BACKGROUND OF THE INVENTION

### Field of the Invention

The present invention relates to eyeglasses with a changeable frame, especially to eyeglasses with a changeable frame, especially to eyeglasses with a changeable frame that is changed into half-frame eyeglasses or full-frame eyeglasses by disassembly of an upper frame and a lower frame according to users' requirements.

### Descriptions of Related Art

Generally, eyeglasses can be categorized into various groups including optical glasses, sunglasses, sports glasses, safety glasses, etc. according to their uses and functions. The frame of the eyeglasses also has different designs. For example, most of optical glasses use a full frame in which lenses are completely enclosed and secured in the frame. As to half-frame eyeglasses, it's lightweight and often applied to sunglasses, sports glasses and safety glasses. Thus users feel easy and convenient while doing outdoor activities, sporting or working.

There are various types of eyeglasses available in the eyeglass stores such as a full frame type, a half frame type, etc in order to meet users' requirements. This results in the increased operating cost for eyeglass retailers. Besides extra protection and vision correction, eyeglasses also become a fashionable accessory. Users can choose the eyewear such as a full frame type, a half frame type, etc. according to the occasions or styles. The eyeglasses have different functions such as sunglasses, sports glasses, etc. Thus people buy a plurality pairs of glasses with different styles and functions and the expenses they spent on the eyeglasses are raised. The storage of the eyeglasses is also troublesome. This also causes waste of materials while the eyeglasses are not in use.

The design of the eyeglass frame available now is limited to a half-frame type or a full-frame type. This is a burden to the eyeglass retailers and consumers. Thus there is room for improvement and a need to provide a novel design of the eyeglass frame.

### SUMMARY OF THE INVENTION

Therefore it is a primary object of the present invention to provide eyeglasses with a changeable frame that is changed into half-frame eyeglasses or full-frame eyeglasses by disassembly of an upper frame and a lower frame according to users' requirements.

In order to achieve the above object, eyeglasses according to the present invention mainly include an upper frame and a lower frame.

The upper frame consists of at least one lens assembly portion with an opening on a lower part thereof and a locking slot disposed on a bottom of each of two sides thereof. Two locking concaves are formed on two opposite side walls of the locking slot respectively.

The lower frame is formed by at least one lens assembly part having an opening on an upper part thereof and a projection disposed on an upper end of each of two sides thereof. The projection includes two corresponding locking pins, a gap between inner sides of the locking pins and a locking protrusion formed on an outer side of each locking pin. The locking protrusions of the locking pins are locked into and connected to each locking concave of the locking slot correspondingly.

The locking concaves of the locking slot of the upper frame are curved. The locking protrusions on the locking pins of the lower frame are also curved so as to lock into the curved locking concaves.

A curved corner is arranged at an end part of each locking pin of the lower frame.

A round corner is located on each of two sides of a bottom of the locking slot and is corresponding to the curved corner on the locking pin of the lower frame.

An interrupted hole is formed at each of two sides of a rear surface of the upper frame. The interrupted hole is corresponding to and communicating with the locking slot.

The interrupted hole of the upper frame is corresponding to the locking concave of the locking slot and two sides of the interrupted hole are extended to the locking concaves of the locking slot.

A temple pivot slot is arranged at each of two sides of the rear surface of the upper frame.

The eyeglasses with a changeable frame of the present invention can be changed into a half-frame type or a full-frame type according to users' needs. Thus the consumers only need to buy one eyeglasses frame and they can save the expenses on the eyeglasses. For eyeglasses retailers, the operating cost is lowered. Moreover, the upper frame and the lower frame of the present invention can have different colors and patterns to provide users more trendy and fashion look. The product of the present invention is more competitive on the market.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a perspective view of an embodiment according to the present invention;

FIG. 3 is a longitudinal sectional view of an embodiment according to the present invention.

### DETAILED DESCRIPTION OF THE PREFERRED EMBODIMENT

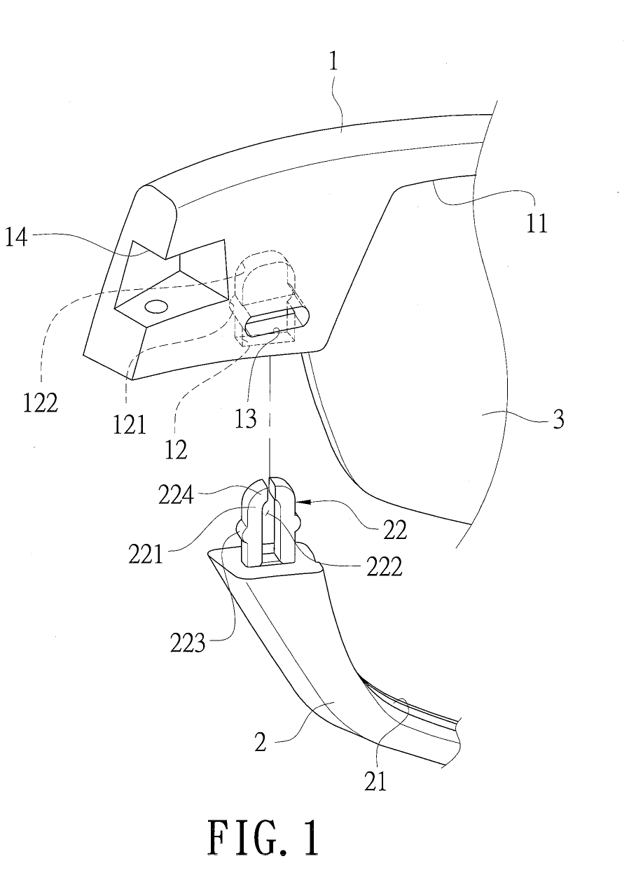

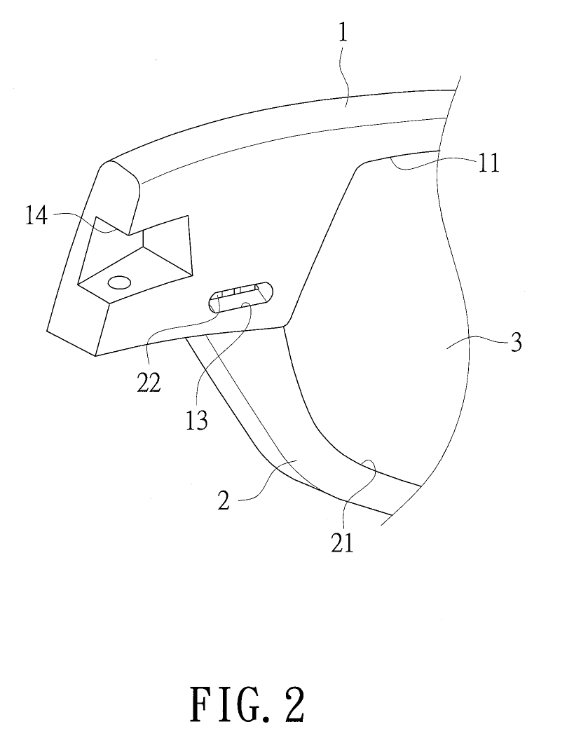

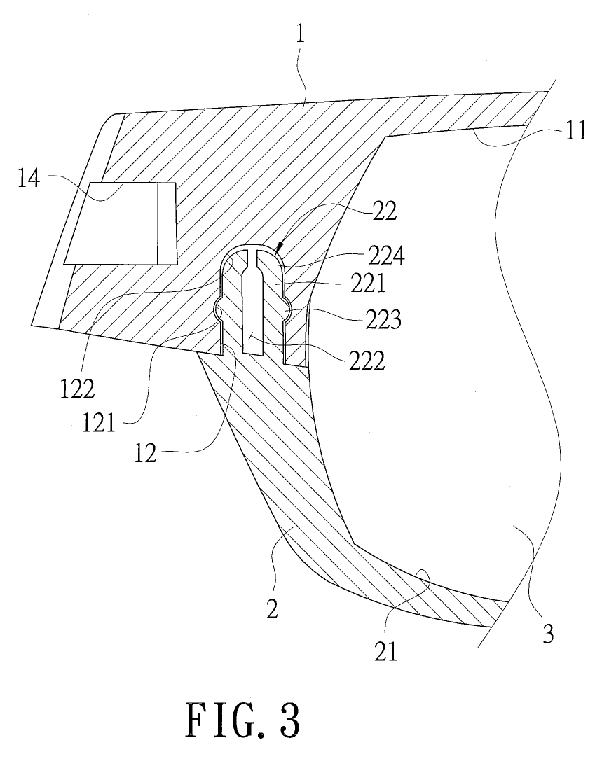

Refer to FIG. 1, FIG. 2 and FIG. 3, eyeglasses with a changeable frame of the present invention includes an upper frame 1 and a lower frame 2.

The upper frame 1 consists of at least one lens assembly portion 11 having an opening on a lower part thereof, a locking slot 12 disposed on a bottom of each of two sides thereof, an interrupted hole 13 formed at each of two sides of a rear surface thereof, and a temple pivot slot 14 arranged at each of two sides of the rear surface thereof. Two locking concaves 121 are formed on two opposite side walls of the locking slot 12 respectively and two round corners 122 are located on each of two sides of a bottom of the locking slot 12. The interrupted hole 13 is corresponding to the locking concave 121 of the locking slot 12 and communicating with the locking slot 12 while two sides of the interrupted hole 13 are extended to the locking concaves 121 of the locking slot 12. The locking concaves 121 are curved.

The lower frame 2 is composed of at least one lens assembly part 21 with an opening on an upper part thereof and a projection 22 disposed on an upper end of each of two sides thereof. The projection 22 is formed by two corresponding locking pins 221, a gap 222 between inner sides of the locking pins 221 and a locking protrusion 223 formed on an outer side of each locking pin 221. The locking protrusions 223 of the locking pins 221 are locked into and connected to the locking concaves 121 of the locking slot 12 correspondingly. The locking protrusions 223 are curved so as to lock into the locking concaves 121 of the locking slots 12. A curved corner 224 is arranged at an end part of each locking pin 221 and is corresponding to the round corner 122 of the locking slot 12.

While being assembled, two temples are pivotally connected to the temple pivot slots 14 of the upper frame 1 respectively. A lens 3 is mounted into the lens assembly portion 11 of the upper frame 1, as shown in FIG. 1 without the lower frame 2. Now a bottom edge of the lens 3 is exposed from the opening on the lower part of the lens assembly portion 11 so as to form half-frame eyeglasses. Thereby the weight of eyeglasses pressed on user's nose bridge and ears is reduced while users doing outdoor activities, or working. Thus the eyeglasses are comfortable and light for all day wear. The appearance of the half-frame eyeglasses is neat and cool so that eyeglass wearers get trendy and fashionable look.

Moreover, the lower frame 2 is connected to the upper frame 1 when users intend to increase the stability and safety of the lens 3 being assembled, as shown in FIG. 2 and FIG. 3. First the projections 22 on the upper edge of the two sides of the lower frame 2 are inserted into the locking slot 12. The locking pins 221 are mounted into the locking slot 12 easily and conveniently by the curved corners 224 at the end part of the locking pins 221. Due to the gap 222 between the locking pins 221, the two locking pins 221 are bent inward so that the locking protrusions 223 can enter the locking slot 12. The locking pins 221 turns back so that the locking protrusion 223 is locked into the locking concave 121 when the locking protrusion 223 of the locking pin 221 reaches the locking concave 121 of the locking slot 12. Thus the upper frame 1 connected to and fixed on the lower frame 2 by the projections 22 engaged in the locking slots 12. Furthermore, the bottom edge of the lens 3 exposed from the lens assembly portion 11 of the upper frame 1 is mounted into the lens assembly part 21 of the lower frame 2 so as to form a full frame type of eyeglasses. Thereby the lens 3 hold by the lens assembly portion 11 of the upper frame 1 and the lens assembly part 21 of the lower frame 2 is assembled more firmly and safely. The lens 3 will not get loose or fall off easily. The full-frame type eyeglasses provide senses of manner and stability.

When the user intends to disassemble the upper frame 1 and the lower frame 2, he/she uses a hand tool is inserted into the locking slot 12 through the interrupted hole 13 on the rear surface of the upper frame 1 for clipping the two locking pins 221 of the lower frame 2 to move inward. Thus the locking protrusions 223 of the locking pins 221 are released from the state being locked by the locking concaves 121 of the locking slot 12. At the moment, the user can pull the projection 22 of the lower frame 2 from the locking slot 12 of the upper frame 1 for separating the lower frame 2 and the upper frame 1 from each other. Thereby the user can changed the eyeglasses to either full-frame type eyeglasses or half-full type eyeglasses according to his/her needs. The upper frame 1 and the lower frame 2 can have different colors and patterns to provide the user a new and stylish look. For consumers who are fond of novelty styles and changing rapidly, they don't need to buy various types of eyeglasses disposed with lenses 3. The expenses on the eyeglasses are significantly decreased. For eyeglasses retailers, their operating cost is also reduced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. Eyeglasses with a changeable frame comprising:
an upper frame having at least one lens assembly portion with an opening on a lower part thereof and a locking slot disposed on a bottom of each of two sides thereof; the locking slot having two locking concaves formed on two opposite side walls thereof respectively; and
a lower frame including at least one lens assembly part having an opening on an upper part thereof and a projection disposed on an upper end of each of two sides thereof; the projection having two locking pins corresponding to each other, a gap formed between inner sides of the locking pins and a locking protrusion formed on an outer side of each locking pin;
wherein the locking protrusions of the locking pins are locked into and connected to the locking concaves of the locking slot respectively.

2. The device as claimed in claim 1, wherein the locking concaves of the locking slot of the upper frame are curved; the locking protrusions on the locking pins of the lower frame are curved so as to lock into the curved locking concaves correspondingly.

3. The device as claimed in claim 1, wherein a curved corner is arranged at an end part of each locking pin of the lower frame.

4. The device as claimed in claim 3, wherein a round corner is disposed on each of two sides of a bottom of the locking slot and is corresponding to the curved corner on each locking pin of the lower frame.

5. The device as claimed in claim 1, wherein an interrupted hole is set at each of two sides of a rear surface of the upper frame; the interrupted hole is corresponding to and communicating with the locking slot.

6. The device as claimed in claim 5, wherein the interrupted hole of the upper frame is corresponding to the locking concave of the locking slot and two sides of the interrupted hole are extended to the locking to concaves of the locking slot.

7. The device as claimed in claim 1, wherein a temple pivot slot is arranged at each of two sides of the rear surface of the upper frame.
